(19) United States
(12) Patent Application Publication
(10) Pub. No.: US 2005/0228966 A1
(43) Pub. Date: Oct. 13, 2005

(54) Processor system and data processing method

(75) Inventor: Akihisa Nakamura, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/800,631

(22) Filed: Mar. 16, 2004

(51) Int. Cl. G06F 15/76

(52) U.S. Cl. 712/1

(57) ABSTRACT

A processor system having a fixed processing unit which has a predetermined information processing function, a variable processing unit which has a variable information processing function, and a control unit which controls so as to cause the fixed processing unit to process a provided task, or so as to cause the variable processing unit to process the task after newly setting an information processing function of the variable processing unit.

### BACKGROUND OF THE INVENTION

Recently, digital processing technologies have been progressed, and for example, with respect to processing of image information, various image processings are carried out by one processor or a plurality of processors. For example, in Jpn. Pat. Appln. KOKAI Publication No. 06-223166, an image processing processor having a plurality of functions is disclosed, and the processor which can vary the functions in accordance with a request is shown.

However, in the prior art, there is the problem that image processing cannot be easily executed because there is no concrete description of how a desired image processing function is concretely realized at the inside of the processor.

### BRIEF SUMMARY OF THE INVENTION

One embodiment of the present invention is a processor system comprising: a fixed processing unit having a predetermined information processing function; a variable processing unit having an information processing function which can be varied; and a control unit which controls so as to cause the fixed processing unit to process a provided task, or so as to cause the variable processing unit to process the task after newly setting an information processing function of the variable processing unit.

### BRIEF DESCRIPTION OF THE SEVERAL VIEWS OF THE DRAWING

FIG. 1 is a diagram showing one example of a block diagram of a processor system according to the present invention.

FIG. 2 is a diagram showing one example of a block diagram showing a configuration of a variable processing unit of the processor system according to the invention.

FIG. 3 is a diagram showing one example of a block diagram showing the details of the configuration of the variable processing unit of the processor system according to the invention.

FIG. 4 is a diagram showing one example of an architecture of identification processing which the processor system according to the invention carries out.

FIG. 5 is a diagram showing one example of the architecture of the identification processing which the processor system according to the invention carries out.

FIG. 6 is a diagram showing one example of the architecture of the identification processing which the processor system according to the invention carries out.

FIG. 7 is a diagram showing one example of the architecture of the identification processing which the processor system according to the invention carries out.

FIG. 8 is a diagram showing one example of an architecture of filtering processing which the processor system according to the invention carries out.

FIG. 9 is a diagram showing one example of an architecture of color conversion processing which the processor system according to the invention carries out.

FIG. 10 is a diagram showing one example of a flowchart showing processings of the processor system according to the invention.

FIG. 11 is a diagram showing one example of a block diagram of a multiprocessor system according to the invention.

FIG. 12 is a diagram showing one example of a block diagram showing the details of a control signal group of the multiprocessor system according to the invention.

FIG. 13 is a diagram showing one example of a block diagram of a CP arbitrating processor of the processor system according to the invention.

FIG. 14 is a diagram showing one example of a flowchart showing processings of the CP arbitrating processor of the multiprocessor system according to the invention.

### DETAILED DESCRIPTION OF THE INVENTION

Hereinafter, embodiments of a processor system according to the present invention will be described in detail with reference to the drawings.

First, one example of the processor system according to the invention will be described in detail with reference to the drawings. Thereafter, a multiprocessor system using a plurality of processor systems as co-processors will be described in detail with reference to the drawings.

<One Example of Processor According to the Present Invention>

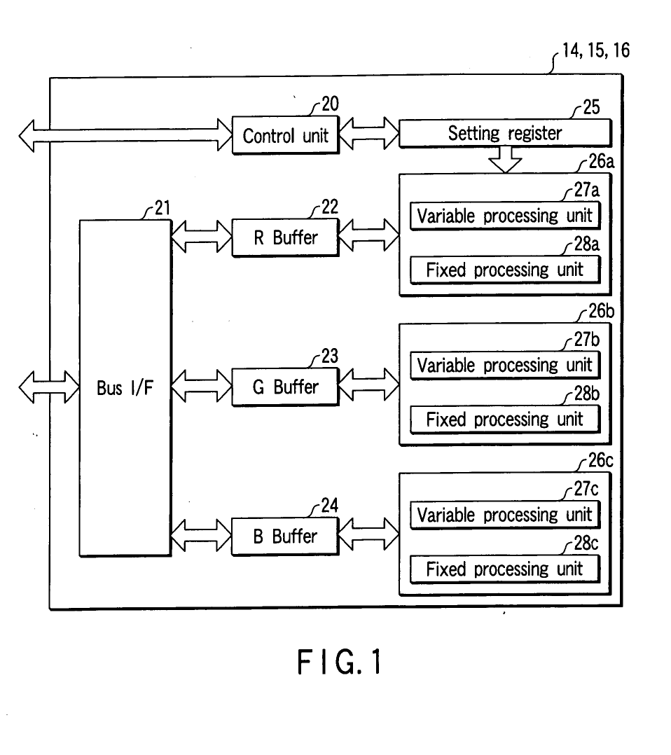

Hereinafter, the basic configuration and the operations of one example of the processor according to the invention will be described with reference to FIGS. 1 to 10.

(Basic Configuration)

As shown in FIG. 1, processor systems 14, 15, and 16 have variable processing units 27a to 27c which can vary an existing circuit function to a desired circuit function by loading connection information, and fixed processing units 28a to 28c having one circuit function. Namely, as shown in FIG. 1, the processor system according to the invention has a control unit 20 which receives a control signal from the exterior and controls the entire operations of the processor 14; a setting register 25 which is connected to the control unit 20, and supplies connection information such as a matrix switch to selectors 104 and 105 which will be described later, or the like; a bus interface 21 which receives, as an example, image information from the exterior; an R buffer 22, a G buffer 23, and a B buffer 24 which receive the image information from the bus interface 21, and which respectively store an R signal, a G signal, and a B signal in storage regions thereof; and a plurality of processing units 26a, 26b, and 26c for each color signal which carry out predetermined processings via these buffers 22, 23, and 24. Moreover, the plurality of processing units 26a to 26c have variable processing units 27 which can vary an existing circuit function to a desired circuit function by loading connection information, and fixed processing units 28 having one circuit function.

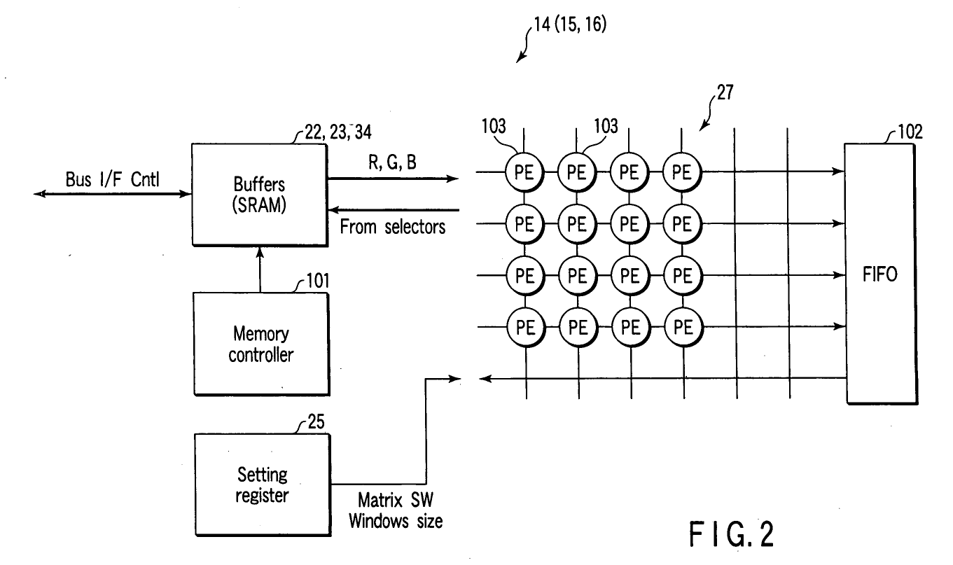

Further, FIG. 2 shows one example of a part of the concrete configuration of the processor system 14, and in the diagram, the processor system 14 has the buffer circuits 22, 23, and 24 to which bus interface control signals BI/FCntl are supplied; a memory controller 101 which is the control unit 20 connected to the buffer circuits 22, 23, and 24, and which controls the operations of the buffer circuits 22, 23, and 24; the setting register 25 which supplies connection information such as a matrix switch to the selectors 104 and 105 which will be described later, in accordance with the control of the control unit 20; PEs (Processing Elements) 103 to which information such as a windows size is supplied from the setting register 25, and which are configured to be a matrix shape, and are to be components of the variable processing unit 27 which can vary a processing function; and a FIFO (First In First Out) 102 which is a storage region connected to the PEs 103.

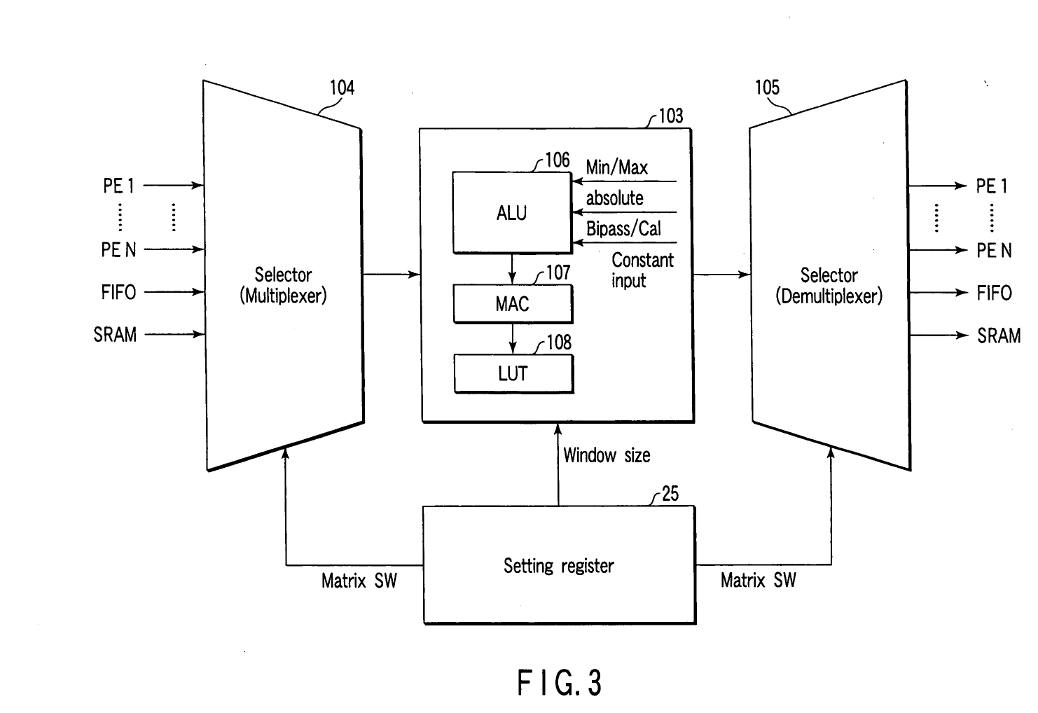

In addition, FIG. 3 is one example showing a detailed part of the concrete configuration of the processor system 14, and in the diagram, the components 103 of the variable processing unit 27 which the processor system 14 has have at least an ALU (Arithmetic Logic Unit) 106, a MAC (Multiplier Accumulate Component) 107, a LUT (Look Up Table) 108, and a functional block with the FIFO 102.

Moreover, a windows size signal is supplied to the components 103 from the setting register 25, and the components 103 have the selector 104 which selects a signal to be supplied to the components 103, and the selector 105 selecting a signal to be outputted from the components 103. The setting register 25 supplies connection information (circuit configuring history register) such as a matrix switch to the selectors 104 and 105, whereby the contents of the register are rewritten. In accordance therewith, the ALU 106, the MAC 107, the LUT 108, and the like of the components 103 of the variable processing unit 27 are appropriately connected to one another, and various modes of processing functions as will be described later (especially, image information processing function) are generated as needed. Further, connection information is preinstalled in the fixed processing unit 28.

(Variable Processing Unit and Fixed Processing Unit)

Namely, in the case of loading only the fixed processing unit 28, the PEs (Processing Elements) are needed for each algorithm, and the fixed processing unit 28 corresponding to an algorithm to be used must be prepared in advance. This causes extreme redundancy, and brings about an increase in the cost.

The variable processing unit 27 compensates for the defect, and it is possible to carry out processing corresponding to the image algorithm which can be thought by the MFP by preparing a computing unit or the like needed for MFP image processing in advance in a unit level. As the embodiment, it goes without saying that the PEs of the respective processors are made to correspond to different algorithms, and as will be described later, all of the variable processing units 27 are applied to filtering operations, a multiprocessor system in which a plurality of processors are provided is configured, and the processings of these variable processing units 27 are concurrently carried out, whereby high-speed processing can be carried out.

Here, the computing unit and the like mean the ALU, the MAC, the LUT, and the FIFO, and these units are connected to signal lines on the matrix, and by switching these contact points by means of the connection information from the register, an arbitrary computing unit can be configured.

In an FPGA (Field Programmable Gate Array) which has been generally known, or the like, because the units are minute, and the redundancies are great, it is difficult to use in this way. Further, there is no variability, in units of computing units, which is specialized to the MFP (Multi-functional Pedestal) as much as this.

(Examples of Image Processing Function)

As image processings of the MFP, there are various processing modes as follows. As the typical examples, there can be provided filtering processing, identification processing, color conversion processing, and the like. Computing units needed for the respective processings are virtually decided as will be described hereinafter. Therefore, it is impossible to correspond to the image processing algorithms other than those thereof. The fixed processing unit 28 is a dedicated processing unit in which an algorithm which can be processed is decided in advance. The respective processings will be described hereinafter.

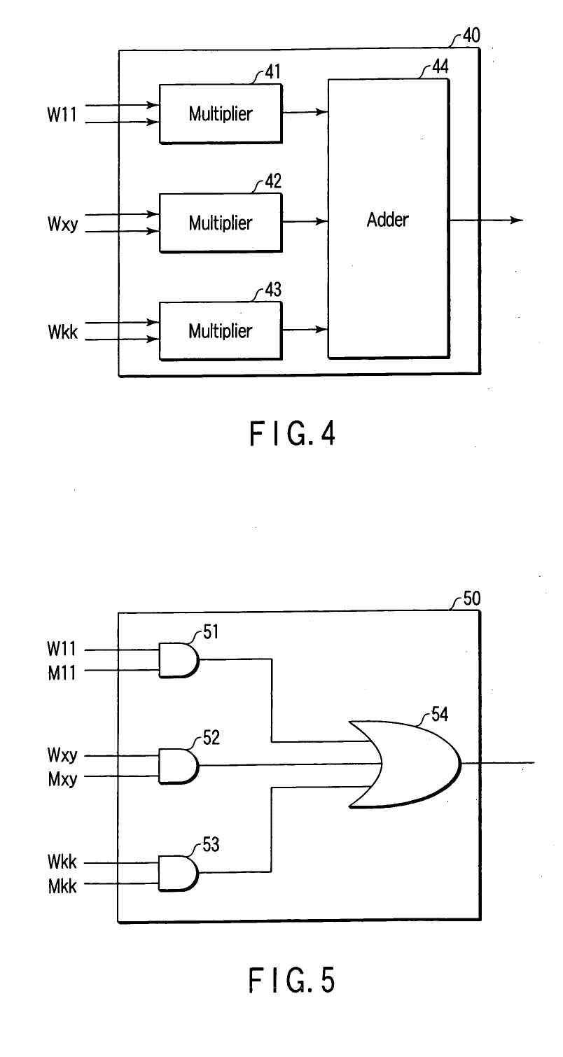

Identification processing 1 shown by the architecture diagram of FIG. 4 is to carry out edge detection (detection of boundary of images) and a computing unit such as that of FIG. 5 is required in order to carry out edge detection. The required basic computing units are a plurality of multipliers 41, 42, and 43, and an adder 44 which receives outputs from the multipliers. The number of the required multipliers and the adder 44 depend on a size of a window used for calculation, and when the window size is K×K, the square number of K is requested.

Next, identification processing 2 shown by the architecture diagram of FIG. 5 is to be executed on an image window of K×K of the input image, and the computing units needed for calculation are AND circuits 51 to 53 and an OR circuit 54 which takes OR of outputs of the AND circuits.

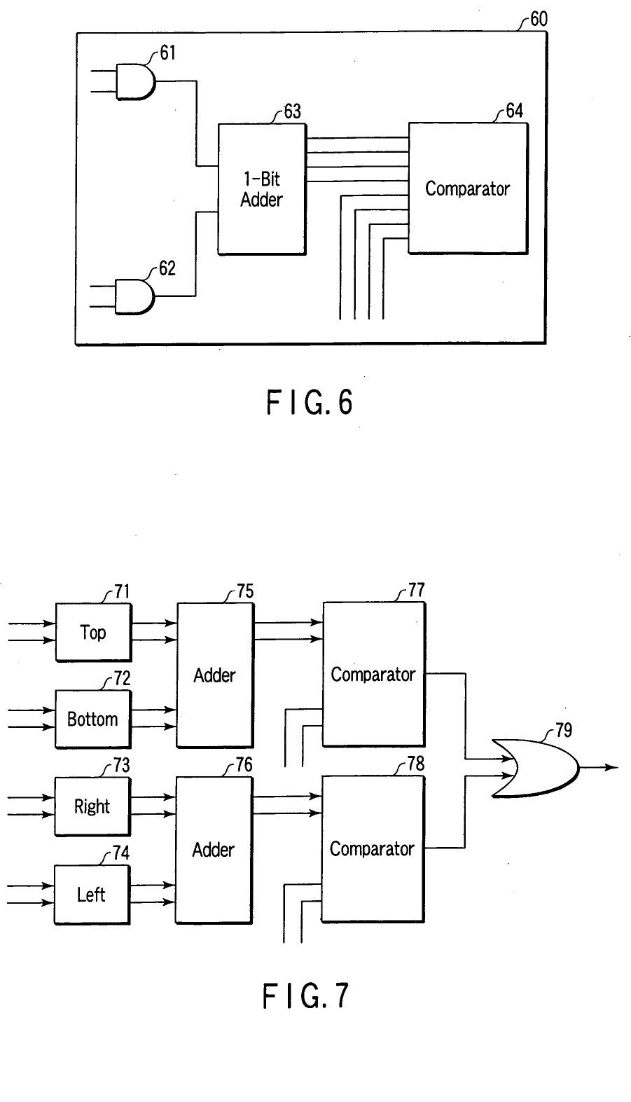

Further, identification processing 3 shown by the architecture diagram of FIG. 6 has a plurality of AND circuits 61 and 62, an adder 63 which adds outputs of the AND circuits, and a comparator 60 which compares the outputs and a predetermined value.

Identification processing 4 shown by the architecture diagram of FIG. 7 uses at least a top pixel 71, a bottom pixel 72, a right pixel 73, and a left pixel 74 which surround an object pixel. Here, when there is provided a threshold number of the object pixel, these information are handled as a set. Moreover, the architecture is configured from adders 75 and 76 for counting the numbers of the respective pixels, and a set of comparators 77 and 78 of AND gates which compare the outputs of the adders. Namely, in the identification processing 4, by using the positions of the four pixels (the top, the bottom, the left, and the right), the positions of the pixels of the top and the bottom are added up, and the two results of the left and right values are compared with a designated threshold value, so that identification of image information is carried out.

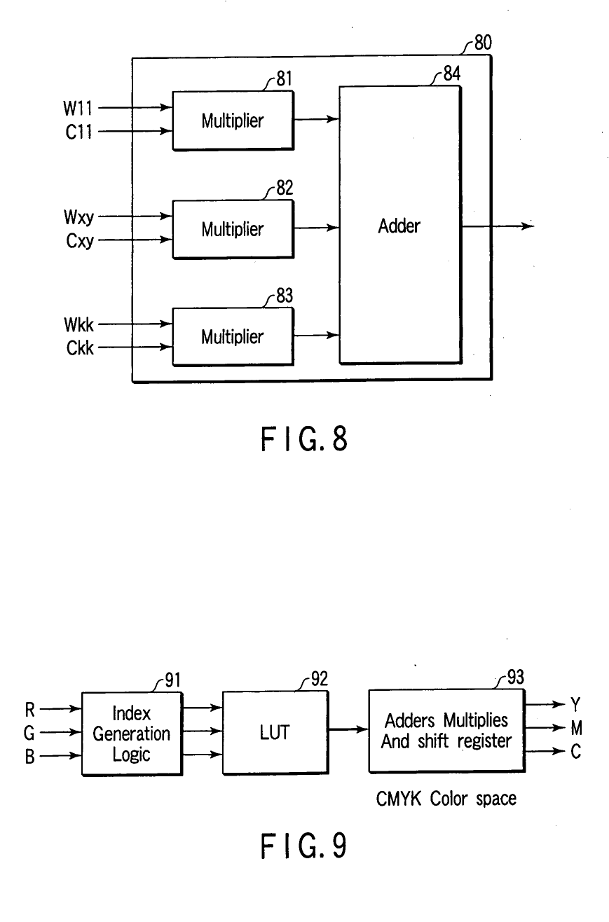

Filtering processing shown by the architecture diagram of FIG. 8 is to carry out filtering processing on image information, and the calculating units needed here are multipliers 81 to 83 and an adder 84 which adds up outputs of the multipliers.

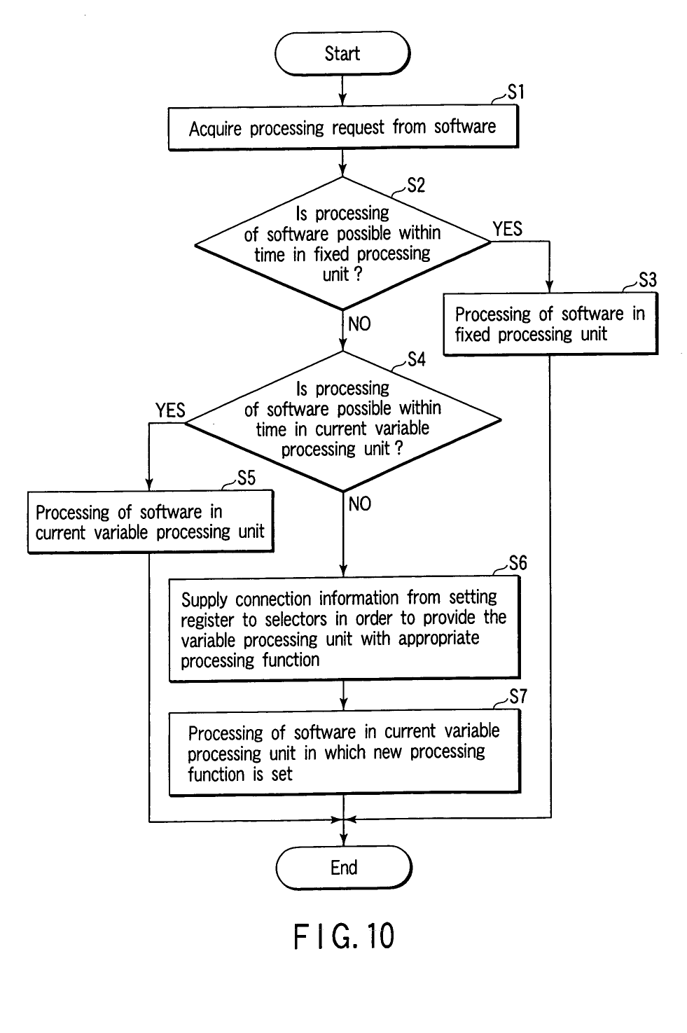

With respect to color conversion processing shown by the architecture diagram of FIG. 9, differently from the other algorithms, color conversion does not need a window for an operation for each pixel. Namely, an RGB signal is converted into a CMY signal by an Adders Multiplies And shift register 93 through a lookup table 92, via an Index generation Logic 91. As the table used for this conversion, there are 729 taking into account the total of a 9×9×9 LUT. Further, the output from the LUT is used for calculating the results as a multiplier, a shifter, an adder, and a cascade of an adder. As one example of the color conversion processing, with respect to one pixel output, nine multipliers and eight adders are required.

(Operations)

Next, one example of the processing operation of the processor system described above will be described in detail hereinafter by using a flowchart of FIG. 10. The processor system 14 shown in FIG. 1 first acquires a request from software provided via an interface at the control unit 20 (S1). In accordance with an analyzing function included in the control unit 20, it is determined whether or not processing is carried out within a time requested by a program, or within a time provided in advance to the control unit 20, by the operation of the current fixed processing unit 28 (S2). Alternatively, without regard to the time here, it is simply determined whether or not the processing can be carried out by the function of the current fixed processing unit 28. When it is determined that the processing can be carried out by the fixed processing unit 28, the processing is made to proceed at the fixed processing unit 28 (S3).

At the control unit 20, when it is determined that the processing cannot be carried out at the current fixed processing unit 28 (S2), it is determined whether or not the processing can be carried out within the time (or without regard to the time) by the function set in the current variable processing unit 27 (S4). When the processing can be carried out by the current variable processing unit 27, the processing is carried out in the current variable processing unit 27 (S5). Here, provided that the processing can be carried out due to the variable processing unit 27 and the fixed processing unit 28 being used together, it is preferable that the processing is carried out by using the variable processing unit 27 and the fixed processing unit 28 together. Further, when it is impossible to carry out the processing by the current variable processing unit 27, in accordance with the processing which the software requires, connection information are supplied from the setting register 25 to the selectors 104 and 105 in order to provide the variable processing unit 27 with an appropriate processing function (S6). In addition, the processing of the software is executed by the variable processing unit 27 in which a novel appropriate processing function is set in accordance with the connection information (S7).

By carrying out such processings, in the processor system, it is possible to carry out the processing which the provided program requires at the highest processing speed within the limited hardware resources.

<Configuration and Operation of Multiprocessor System>

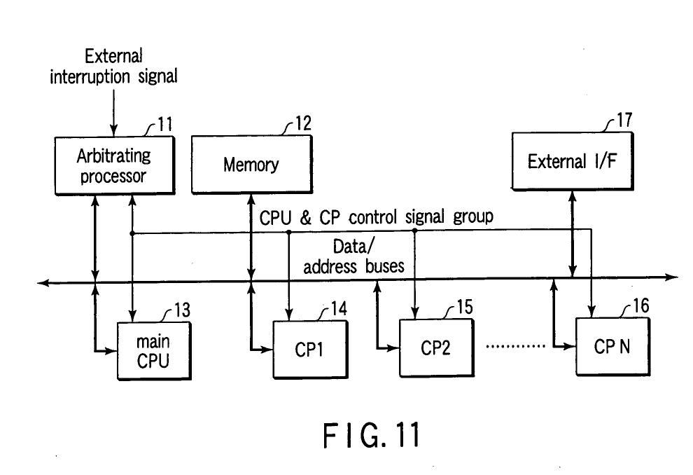

Next, the multiprocessor system using the plurality of processor systems described above will be described with reference to FIGS. 11 to 14.

(Configuration)

As shown in FIG. 11, the multiprocessor system in which the plurality of processor systems are provided as co-processors has a main CPU (hereinafter, CPU) 13, a plurality of CPs 14, 15, and 16 which are connected the main CPU via an address bus, and which are the processor systems described above, a memory 12 connected to a data bus, an external interface 17 for carrying out communication with the exterior, and an arbitrating processor 11 for carrying out the optimum allocation of processings with the CPU 13 and the plurality of CPs 14, 15, and 16.

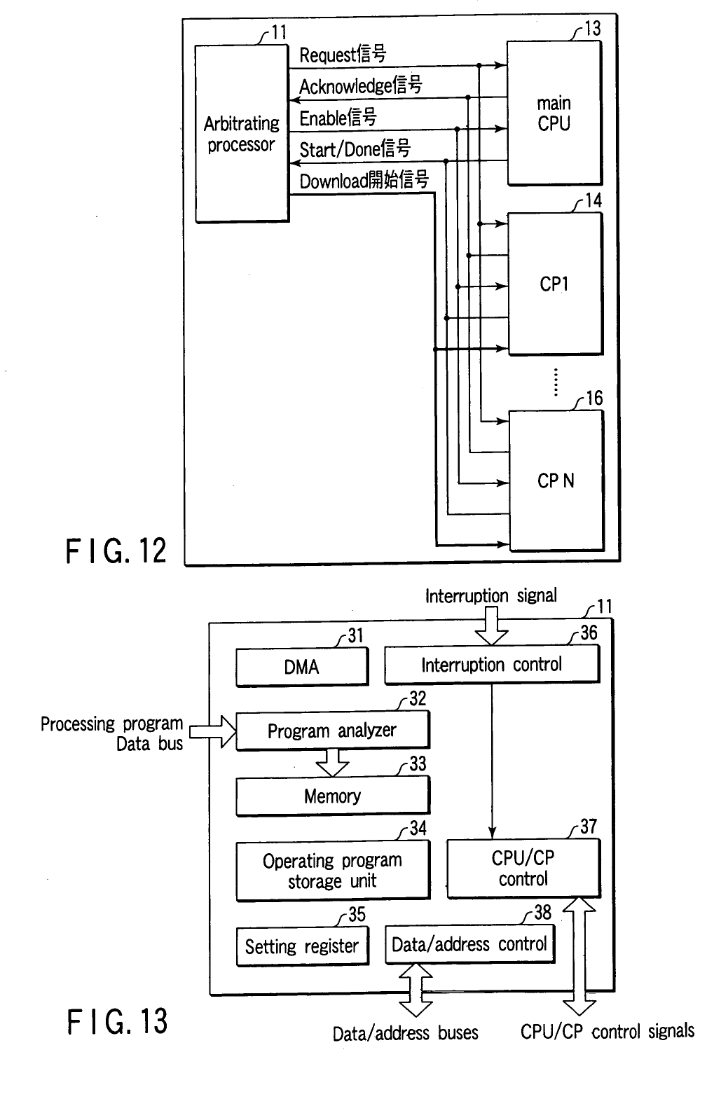

Further, as shown in FIG. 12, the respective blocks are connected by the data/address buses, and CPU and CP control signals are supplied thereto. Communications between the system and the other systems are carried out via an external interruption terminal provided at the arbitrating processor 11, and the external I/F 17.

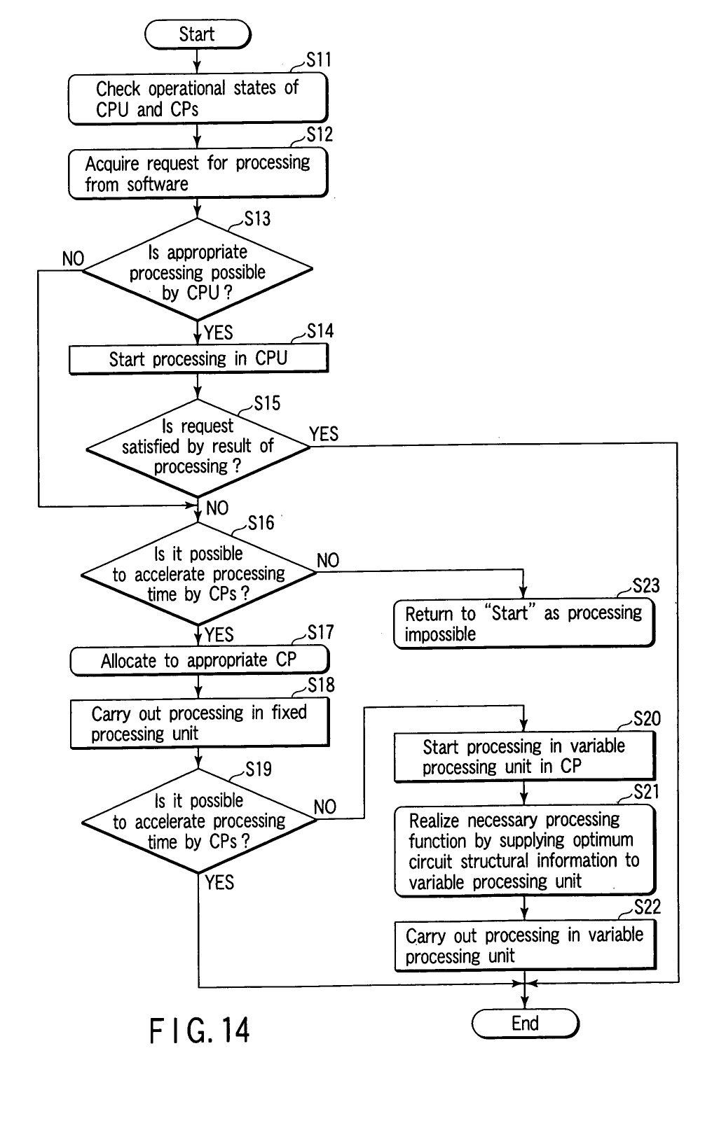

Furthermore, as shown in FIG. 13, the arbitrating processor 11 has a DMA (Direct Memory Access) 31, a program analyzer 32 which receives a processing program and a data bus, a memory 33 connected to the program analyzer 32, an operating program storage unit 34 which stores an operating program therein, a setting register 35 which stores register information which is connection information, or the like in a plurality of CPs or the like, a data/address control unit 38 which transmits and receives data and addresses, an interruption control unit 36 which receives an interruption signal, and a CPU/CP control unit 37 to which the interruption signal is supplied from the interruption control unit 36.

Moreover, the arbitrating processor 11 is to carry out the optimum allocation of a provided program (task) with respect to a parallel processor (the CPU 13, the CP 14 and the like are collectively called such as) in accordance with a processing function or a processing speed which the software requires.

Here, the arbitrating processor 11 is to carry out the optimum allocation with respect to a parallel processor of the provided program (task) in accordance with a processing function or a processing speed which the software requires.

As described above, the processor systems described above are used as the respective CPs 14, 15, and 16 used here, and the fixed processing unit 28 and the variable processing unit 27 are provided. As one example, a processing mode is preferable in which a desired high-speed processing is carried out in the fixed processing unit 28, and a special image processing which the program requires is carried out in the variable processing unit.

By appropriately combining these functions, an attempt can be made to improve a processing speed by the CP number times at the maximum. Namely, by independently providing an arbitrating processor for dedicatedly carrying out arbitration processing of the parallel processor, a multiprocessor system in which a maximum processing efficiency can be realized.

(Arbitrating Operation)

Next, processing operations including the arbitrating operation of such a multiprocessor system will be described in detail hereinafter with reference to a flowchart shown in FIG. 14. As shown in the flowchart of FIG. 14, the arbitrating processor 11 periodically carries out the check of an operational state of the parallel processors via a CPU-and-CP signal group, and is able to immediately execute with respect to external interruptions (a request signal and an acknowledge signal) (S11). Next, at the same time when a processing request of the software arrives via an interruption signal line, the requested software is written in the memory 33 in the arbitrating processor 11 (S12).

The arbitrating processor 11 analyzes the processing contents requested in advance, by the program analyzer 32, and it is determined whether or not the processing is completed within a requested time in an operational state of the current CPU 13 (S13). When the processing can be carried out within the requested time, the processing is started at the CPU 13 (S14). Due to the processing being carried out by only the CPU 13, it is possible to reduce the electric power consumption. Further, by comparing the requested time set in advance and an execution time (the time is measured by Start/Done signals) with one another, the execution time is verified, and when the requested time and the result are satisfied (S15), the processing is completed at that point in time.

Moreover, when the estimated result does not reach the requested time (S15), in the case where it is possible to accelerate the processing time by using some or all of the CPs 14, 15, and 16 (S16), the states of the CPs 14, 15, and 16 are checked in advance, and in accordance therewith, a task of the program is allocated to a CP, among the CPs 14, 15, and 16, which can appropriately process, and the processing is started (S17). When further acceleration is impossible, and the requested time cannot be satisfied, the routine returns to the start as processing impossible (S23).

Namely, when it is possible to accelerate the processing time by using some or all of the CPs 14, 15, and 16, by allocating the task of the program to an appropriate CP, the task is processed at the fixed processing units 28 of some of or all of the CPs 14, 15, and 16 (S18). However, when the request is not satisfied due to the processing as well (S19), in order to start the processing in the variable processing units 27 of some or all of the CPs 14, 15, and 16, a shortage of the time is calculated, and the number of the CPs needed for reaching the target time is estimated (S20). Further, it is determined whether it is possible to execute the processing by the preinstalled fixed processing unit 28, or the circuit structural information (connection information) of the fixed processing unit 28 must be supplied to the variable processing unit 27.

In accordance therewith, for example, when it is possible to execute the task of the program by the existing fixed processing unit 28, by copying the circuit structural information from the registers of the fixed processing units 28 of some or all of the CPs 14, 15, and 16, to a register of the variable processing unit 27 in another CP (the copying-original CP and the copying-destination CP are designated by a download start signal address), or by supplying the circuit structural information prepared in advance to the variable processing unit 27, the optimum circuit structural information is realized in the variable processing unit (S21). Accordingly, by utilizing the variable processing unit 27 (or using along with the fixed processing unit 28 together), the processing of the task of the program is executed.

As described above in detail, in the processor system and the multiprocessor system using the processor system as the CPs, due to the operation of the control unit 20 in the processor, or due to the operation of the arbitrating processor 11 in the multiprocessor system, by generating an appropriate processing function in, not only the fixed processing unit 28, but also the variable processing unit 27 as needed, and by using the function, it is possible to process the task which the program requests at a high-speed.

Further, the method described above is one example, and for example, there is not necessarily need to strictly estimate and examine the processing time, and the same operational effects can be obtained by a method in which it is determined whether or not it is possible to execute a task of a type which the program requests, and the configuration of the variable processing unit is appropriately varied.

In accordance with various embodiments described above, those skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

1. A processor system comprising:
a fixed processing unit having a predetermined information processing function;
a variable processing unit having a variable information processing function; and
a control unit which controls so as to cause the fixed processing unit to process a provided task, or so as to cause the variable processing unit to process the task after newly setting an information processing function of the variable processing unit.

2. The processor system according to claim 1, wherein the control unit analyzes the provided task, and controls so as to cause the variable processing unit to process the task after newly setting an information processing function of the variable processing unit in accordance with a result of the analysis.

3. The processor system according to claim 1, wherein the variable processing unit has at least one of an ALU, a MAC, a LUT, and a FIFO, and realizes a new information processing function in accordance with connection information provided from the control unit.

4. The processor system according to claim 1, wherein the fixed processing unit and the variable processing unit are provided as a plurality of sets in accordance with a plurality of image signals, and respectively process said plurality of image signals in parallel.

5. The processor system according to claim 1, further comprising:
a plurality of co-processors having the fixed processing unit, the variable processing unit and the control unit;
a main processor which preferentially processes the task; and
an arbitrating unit which analyzes the task, and allocates the task to said plurality of co-processors in accordance with a result of the analysis.

6. The processor system according to claim 5, wherein the arbitrating unit analyzes the task, and in accordance with a result of the analysis, determines whether the task is allocated to only the main processor or the task is allocated to the main processor and said plurality of co-processors.

7. The processor system according to claim 5, wherein the arbitrating unit calculates a processing time in a case of analyzing and processing the task by only the main processor, and on the basis of the calculated time, determines whether or not the task is processed by only the main processor.

8. The processor system according to claim 1, wherein the variable processing unit has a function of carrying out filtering processing on image information to be provided.

9. The processor system according to claim 1, wherein the variable processing unit has a function of carrying out identification processing on image information to be provided.

10. The processor system according to claim 1, wherein the variable processing unit has a function of carrying out color conversion processing on image information to be provided.

11. A processing method of a processor system, comprising:
determining on causing at least one of a fixed processing unit and a variable processing unit to process with respect to a processor system which has the fixed processing unit having a predetermined information processing function, and the variable processing unit having a variable information processing function; and
controlling so as to cause the fixed processing unit to process a provided task, or so as to process the task after newly setting an information processing function of the variable processing unit.
